(19) United States
(12) Patent Application Publication
(10) Pub. No.: US 2026/0027826 A1
(43) Pub. Date: Jan. 29, 2026

(54) PRINT ELEMENT SUBSTRATE, LIQUID EJECTION HEAD, AND LIQUID EJECTION APPARATUS

(71) Applicant: CANON KABUSHIKI KAISHA, Tokyo (JP)

(72) Inventors: KOUSUKE KUBO, Kanagawa (JP); YASUHIRO SOEDA, Kanagawa (JP)

(21) Appl. No.: 19/273,435

(22) Filed: Jul. 18, 2025

(30) Foreign Application Priority Data
Jul. 26, 2024 (JP) 2024-121183

(51) Int. Cl. B41J 2/14; B41J 2/045

(52) U.S. Cl. CPC B41J 2/14153; B41J 2/04563; B41J 2/0458; B41J 2/14072

(57) ABSTRACT

The purpose of the present disclosure is to provide a print element substrate capable of accurately detecting temperature over the entire area and performing high-precision temperature control. The print element substrate includes an energy generating element array, a temperature detection element array, a heating element array, and a plurality of unit areas each including an energy generating element, a temperature detection element, and a heating element. Among the plurality of unit areas, compared to a first unit area arranged in a near of a center of the print element substrate, in a second unit area arranged at a position near a first end portion of the print element substrate, the temperature detection element is arranged at a position close to the first end portion.

### BACKGROUND

### Field of the Technology

The present disclosure relates to a print element substrate, a liquid ejection head, and a liquid ejection apparatus.

### Description of the Related Art

Print element substrates used in a liquid ejection apparatus that performs printing by ejecting liquid exhibit changes in the droplet amount and ejection speed of the ejected liquid depending on their temperatures. In a case where a temperature distribution occurs in a print element substrate, the temperature distribution may directly cause unevenness in an image, resulting in a concern about deterioration in image quality. Therefore, in print element substrates, temperature control is required so that the temperature distribution within the substrates is maintained within an appropriate range. Japanese Patent Laid-Open No. 2017-213874 discloses a print element substrate in which a plurality of heating areas, each including a heater for liquid ejection, a sub-heater for temperature adjustment, a driver for driving these heaters, and a temperature detection element for detecting the temperature of the element substrate are installed evenly on the left and right sides. According to the print element substrate disclosed in Japanese Patent Laid-Open No. 2017-213874, it becomes easier to equalize the temperatures among the plurality of heating areas, thereby implementing suppression of deterioration in image quality.

In the print element substrate disclosed in Japanese Patent Laid-Open No. 2017-213874, a heater, a sub-heater, a driver, and a temperature detection element are arranged in such a manner that their positional relationships are identical in all heating areas (unit areas). Therefore, in the entire print element substrate viewed as a whole, the end portions where heat particularly easily escapes to the surroundings tend to have a temperature distribution with a greater gradient than that of the central portion within a unit area, making it difficult to detect an accurate average temperature within the unit area, resulting in a case where appropriate temperature control cannot be performed.

### SUMMARY

The purpose of the present disclosure is to provide a print element substrate capable of accurately detecting temperature over the entire area and performing high-precision temperature control.

A print element substrate according to the present disclosure includes: a print element substrate for printing by ejecting liquid, the print element substrate including: an energy generating element array configured with a plurality of energy generating elements arranged along a first direction to generate energy for ejecting the liquid; a temperature detection element array configured with a plurality of temperature detection elements arranged along the first direction to detect a temperature of the print element substrate; a heating element array configured with a plurality of heating elements arranged along the first direction to heat the print element substrate; and a plurality of unit areas each configured to include at least one of the energy generating elements, at least one of the temperature detection elements, and at least one of the heating elements, wherein, among the plurality of unit areas, compared to a first unit area arranged in a near of a center of the print element substrate, in a second unit area arranged at a position near a first end portion of the print element substrate, the temperature detection element is arranged at a position close to the first end portion.

Features of the present disclosure will become apparent from the following description of embodiments with reference to the attached drawings. The following description of embodiments is described by way of example.

### BRIEF DESCRIPTION OF THE DRAWINGS

FIG. 1A is a perspective view illustrating an example of a liquid ejection apparatus according to an embodiment;

FIG. 1B is a block diagram of a control system of the liquid ejection apparatus;

FIG. 2 is a schematic perspective view of a liquid ejection head according to an embodiment;

FIG. 3 is a schematic plan view of an element substrate according to an embodiment;

FIG. 4 is a diagram illustrating a circuit for driving heating elements;

FIG. 5 is a block diagram illustrating a state in which control signals for heating elements are generated within the element substrate;

FIG. 6 is a block diagram illustrating a state in which selection signals for temperature detection elements are generated within the element substrate;

FIG. 7 is a block diagram illustrating a state in which control signals for heating elements are supplied from outside the element substrate;

FIG. 8 is a plan view illustrating an example of an element substrate according to an embodiment;

FIG. 9 is a plan view illustrating an example of an element substrate according to an embodiment;

FIG. 10 is a plan view illustrating an example of an element substrate according to an embodiment;

FIG. 11 is a plan view illustrating an example of an element substrate according to an embodiment; and

FIG. 12 is a plan view illustrating an example of an element substrate according to an embodiment.

### DESCRIPTION OF THE EMBODIMENTS

### First Embodiment

### <Liquid Ejection Apparatus 100>

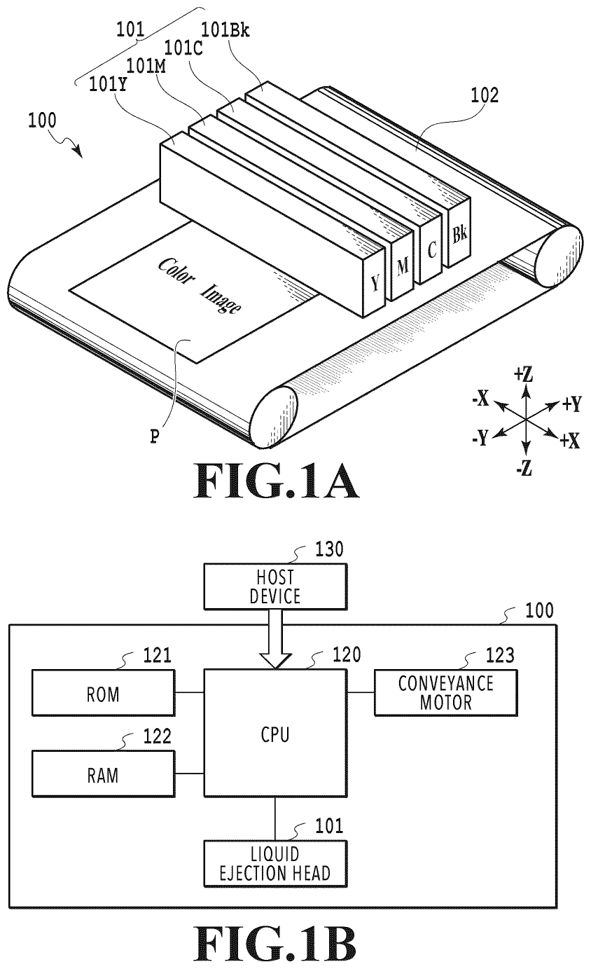

FIG. 1A is a perspective view illustrating an example of the liquid ejection apparatus 100 applicable to the present embodiment.

A description is given about coordinate axes illustrated in the drawings. The +X direction indicates the longitudinal direction of the liquid ejection head 101. The +Y direction indicates the transverse direction of the liquid ejection head 101. The −Y direction is the conveyance direction of the printing medium P. The −Y direction may be referred to as the conveyance direction, as appropriate. The Z direction indicates the height direction of the liquid ejection head 101. The −Z direction is the direction in which liquid (e.g., ink) is ejected from the liquid ejection head 101. The surface of the liquid ejection head 101 that faces the −Z direction are the bottom surface of the liquid ejection head 101.

In the present disclosure, the term “printing” does not exclusively refer to formation of meaningful information (e.g., characters or figures made visible to be perceptible to human vision). The term “printing” also refers to formation of meaningless information. Furthermore, in the present disclosure, the term “printing” also broadly refers to forming an image, a design, a pattern, a structure, or a combination of these on the printing medium P, or to performing processing on the medium.

The term “printing medium” includes not only paper used in general liquid ejection apparatuses, but also materials such as cloth, plastic film, metal plate, glass, ceramics, resin, wood, leather, and others that can receive liquid (e.g., ink).

Note that the printing medium P may be anything as long as it allows droplets (e.g., ink droplets) to land thereon to form an image. For example, various materials and forms such as paper, cloth, label surfaces of optical discs, plastic sheets, OHP sheets, and envelopes can be used. In the present embodiment, the following description assumes a case where cut sheet is used as the printing medium P.

In the present embodiment, the description assumes a case where ink is used as the liquid. However, the liquid that can be used in the technology of the present disclosure is not limited to ink. Other than ink, various types of printing liquids can be used as the liquid, such as processing liquids used for the purpose of improving the fixability of ink on the printing medium P, reducing gloss unevenness, enhancing abrasion resistance, or the like.

As illustrated in FIG. 1A, the liquid ejection apparatus 100 includes the elongated liquid ejection head 101 that extends across the entire area in the width direction (the X direction) of the printing medium P. In the present embodiment, a so-called full-line type liquid ejection head 101 is used.

The printing medium P is continuously conveyed in the conveyance direction by the conveyance mechanism 102 including a conveyance belt, etc. While the printing medium P is being conveyed in the conveyance direction, printing on the printing medium P is performed by ejecting liquid (e.g., ink) from the liquid ejection head 101. In the present embodiment, as the liquid ejection head 101, the liquid ejection heads 101C, 101M, 101Y, and 101Bk that eject cyan (C), magenta (M), yellow (Y), and black (Bk) ink, respectively, are used. This makes it possible to form a color image.

FIG. 1B is a block diagram of the control system of the liquid ejection apparatus 100.

As illustrated in FIG. 1B, the CPU 120 controls the entire liquid ejection apparatus 100 in accordance with a program stored in the ROM 121 while using the RAM 122 as a work area.

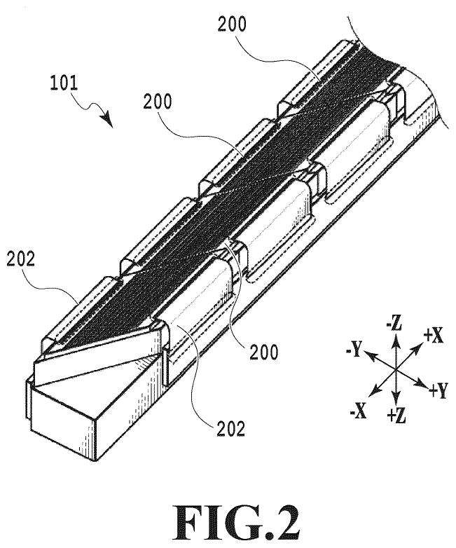

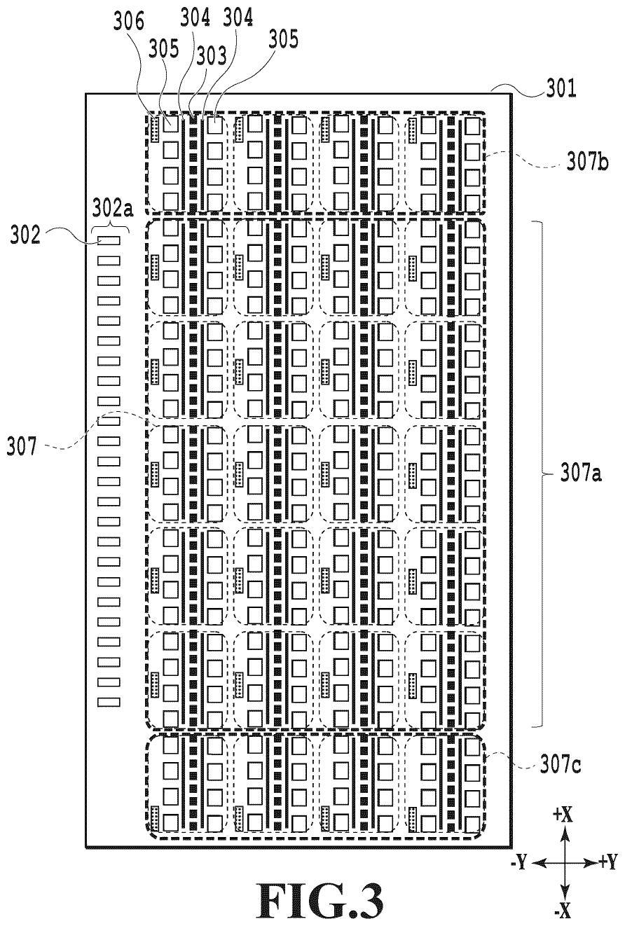

For example, the CPU 120 controls the temperatures of the print element substrates 200 (see FIG. 2) by driving the heating elements 304 (see FIG. 3) based on the temperatures obtained by the later-described temperature detection elements 306 (see FIG. 3).

Furthermore, the CPU 120 performs predetermined image processing on image data, which is received from the host device 130 connected externally, in accordance with programs and parameters stored in the ROM 121, and generates ejection data compatible with the liquid ejection head 101. Then, the liquid ejection head 101 is driven in accordance with the ejection data to eject liquid at a predetermined frequency from individual ejection ports (not illustrated in the drawings). Furthermore, while performing such an ejection operation by the liquid ejection head 101, the conveyance motor 123 is driven to rotate the conveyance mechanism 102 (see FIG. 1A), thereby conveying the printing medium P (see FIG. 1A) in the conveyance direction at a speed corresponding to the ejection frequency.

### <Liquid Ejection Head 101>

FIG. 2 is a schematic perspective view of the bottom surface of the liquid ejection head 101 applicable to the present embodiment.

As illustrated in FIG. 2, in the present embodiment, the full-line type liquid ejection head 101 is used, in which a plurality of print element substrates 200 is arranged along a direction (e.g., the X direction) intersecting (substantially orthogonally in the case of the present embodiment) the conveyance direction. The print element substrates 200 is each equipped with the element substrate 301 (see FIG. 3), which includes energy generating elements that generate energy for ejecting liquid, and an ejection port forming member (not illustrated in the drawings) in which ejection ports (not illustrated in the drawings) for ejecting liquid are formed.

The ejection port forming member includes pressure chambers, which temporarily store liquid supplied from the supply ports 305 (see FIG. 3) and receive pressure during the ejection of the liquid, and ejection ports formed at positions corresponding to the energy generating elements. Note that, in FIG. 2, in the bottom view of the liquid ejection head 101, the print element substrate 200 is shown as having a parallelogram shape. However, it is also possible that the shape of the print element substrate 200 is rectangular (e.g., a rectangle). In the following description, the shape of the print element substrate 200 is assumed to be a rectangle.

Further, in FIG. 2, pad arrays 302a (see FIG. 3) are formed along the X direction at both the end portion on the +Y direction side and the end portion on the −Y direction side of the print element substrates 200, and the flexible wiring substrates 202 are connected to the pad arrays, respectively. However, it is also possible to adopt a form in which the pad arrays 302a and the flexible wiring substrates 202 are arranged on either the +Y direction side or the −Y direction side of the print element substrates 200. In the present embodiment, a configuration in which the pad arrays 302a are formed only on the —Y direction side is described.

### <Element Substrate 301>

FIG. 3 is a schematic bottom view of the element substrate 301 applicable to the present embodiment. Note that, in FIG. 3, broken lines indicating areas are illustrated, but these broken lines are hypothetical lines presented for convenience of explanation.

As illustrated in FIG. 3, the element substrate 301 is equipped with the pad 302, to which the flexible wiring substrate 202 (see FIG. 2) can be connected, and the heater 303 that serves as an energy generating element for ejection. The element substrate 301 is equipped with the heating elements 304 that perform heating control of the element substrate 301, the supply ports 305 that supply liquid, and the temperature detection element 306 that detects temperature. A plurality of the heaters 303 is arranged along a first direction (the longitudinal direction, i.e., the X direction, of the element substrate 301), thereby forming an energy generating element array (a heater array).

In the plan view of the bottom surface of the element substrate 301, the heating elements 304 that heat the element substrate 301 are arranged on both sides of the heater array. A plurality of the heating elements 304 is arranged along the first direction, thereby forming heating element arrays.

In the plan view of the bottom surface of the element substrate 301, the supply ports 305 for supplying liquid from the element substrate 301 to an ejection port forming member (not illustrated in the drawings) are formed on the outer sides of the two heating elements 304 so as to penetrate the element substrate 301 in the height direction (the Z direction). A plurality of the supply ports 305 is arranged along the first direction, thereby forming supply port arrays. Note that the ejection port forming member (not illustrated in the drawings) is bonded to the surface facing the near side in FIG. 3. The liquid is supplied through the supply ports 305 to the upper layer of the heaters 303 (the surface facing the near side in FIG. 3). Then, upon heat generation by the heaters 303, film boiling occurs in the liquid, so that the liquid is ejected from the ejection ports of the ejection port forming member toward the −Z direction side (the near side in FIG. 3) in accordance with the growth of the generated bubbles.

In the plan view of the bottom surface of the element substrate 301, the temperature detection element 306 for detecting the temperature of the element substrate 301 is arranged on the left side of the supply port array formed on the left side of each heater array. A plurality of the temperature detection elements 306 is arranged along the first direction, thereby forming a temperature detection element array. The element substrate 301 includes a plurality of unit areas 307, each of which is a unit for temperature control and includes a plurality of the energy generating elements (the heaters 303 in the present embodiment), two of the heating elements 304, and one of the temperature detection elements 306. The heating elements 304 are the elements for heating the element substrate 301 and the liquid and keeping them warm. That is, the heating elements 304 function as sub-heaters. The heating elements 304 are symmetrically formed into arrays on both sides of each heater array.

In the present embodiment, the liquid has a property that its viscosity decreases at high temperature. Therefore, in a case where the liquid is heated using the heating elements 304 asymmetrically arranged with respect to a heater array, the balance of viscosity between the left and right sides may be disrupted, resulting in an asymmetric liquid bubbling shape. As a consequence, the accuracy of the landing positions of ejected droplets on the cut sheet may deteriorate. Accordingly, in the present embodiment, by symmetrically arranging the heating elements 304 with respect to a heater array, the influence on the landing accuracy of droplets caused by the heating with the heating elements 304 is suppressed.

In the present embodiment, the twenty-eight unit areas 307, each including eight heaters 303, are installed as the minimum sections. The unit areas 307 installed as the minimum sections are arranged such that seven of them are installed along the first direction and four of them are installed along the second direction (the transverse direction, i.e., the Y direction, of the element substrate 301). In each of these unit areas 307, one temperature detection element 306 for detecting the temperature of the element substrate 301 and two heating elements 304 are arranged as one set. Note that each unit area 307 in the present embodiment includes eight supply ports 305 (two of the supply port arrays). In this manner, in all of the unit areas 307, the heaters 303, the heating elements 304, and the supply ports 305 are each arranged in the same numbers.

Note that the numbers of the supply ports 305, the heaters 303, the heating elements 304, and the temperature detection elements 306 are not limited to the above-described numbers. As long as they can be arranged inside one unit area 307, there is no limitation on the numbers of the supply ports 305, the heaters 303, the heating elements 304, and the temperature detection elements 306.

In the present embodiment, two supply ports 305 are arranged on each side of one heater 303. By arranging two supply ports 305 symmetrically for one heater 303, the bubbling of the liquid also becomes symmetrical, and the ejected liquid accurately lands on the sheet surface, thereby implementing high image quality. Further, by supplying the liquid from the supply ports 305 on both sides of the heaters 303 after ejection, the ejection frequency can be increased, and high-speed operation can also be implemented.

In the present embodiment, the element substrate 301 is divided into the first area 307a, the second area 307b, and the third area 307c for temperature control.

In the plan view of the bottom surface of the element substrate 301, the first area 307a is located in the central portion of the element substrate 301 with respect to the longitudinal direction (the X direction). The first area 307a includes twenty unit areas 307 out of the above-described twenty-eight unit areas 307. These twenty unit areas 307 are arranged such that five of them are installed along the first direction and four of them are installed along the second direction (the transverse direction, i.e., the Y direction, of the element substrate 301) that intersects (orthogonally in the present embodiment) the first direction (the X direction).

The second area 307b is located at the end portion on the +X direction side of the first area 307a. In the second area 307b, the four unit areas 307 are installed along the second direction.

The third area 307c is located at the end portion on the −X direction side of the first area 307a. In the third area 307c, the four unit areas 307 are installed along the second direction.

In each of the twenty unit areas 307 installed in the first area 307a, the temperature detection element 306 is arranged at the center with respect to the first direction. In each of the four unit areas 307 installed in the second area 307b, the temperature detection element 306 is arranged as close to the end portion on the +X direction side of the second area 307b as possible. In each of the four unit areas 307 installed in the third area 307c, the temperature detection element 306 is arranged as close to the end portion on the −X direction side of the third area 307c as possible. In this manner, in the second area 307b and the third area 307c, the temperature detection elements 306 are arranged at positions close to the end portions of the element substrate 301 so as to be as far away from the center of the element substrate 301 as possible.

In the present embodiment, the temperature detection element 306 is installed in each unit area 307, so that the heating by the heating elements 304 included in the same unit area 307 is controlled based on the temperature detected by the temperature detection element 306. Although the number of times the heaters 303 are driven per unit time and the degree of heat generation vary depending on the image data, temperature variations within the element substrate 301 can be suppressed by continuously controlling the heating by the heating elements 304 for each unit area.

Compared to the unit areas 307 within the first area 307a, the unit areas 307 within the second area 307b and the third area 307c tend to allow heat to escape to the outside of the element substrate 301 more easily, resulting in greater temperature unevenness. If the temperature detection elements 306 are arranged at the center of the X direction in the second area 307b, the temperature at the end portion in the +X direction is hardly reflected in the detected temperature information, and there is a possibility that a temperature higher than the actual average temperature within the unit area 307 will be detected. As a result, there is a possibility that heating control by the heating elements 304 will not be performed appropriately.

Therefore, in the second area 307b, the temperature detection elements 306 are arranged on the +X direction side relative to the center in the X direction, so that the temperature information obtained by the temperature detection elements 306 is likely to include information on that end portion. Thus, as temperature information for the entire unit areas 307, the temperature detection elements 306 obtain temperature information weighted toward the end portion temperature, which tends to be relatively low, and thus this temperature comes close to the actual average temperature of the entire unit areas 307. As a result, the heating control by the heating elements 304 is performed more appropriately. For the same reason, in the third area 307c, the temperature detection elements 306 are arranged on the −X direction side relative to the center in the X direction.

In the first area 307a, the temperature is generally uniform and temperature unevenness is less likely to occur, compared to the second area 307b and the third area 307c. Therefore, in each unit area 307 of the first area 307a, the temperature detection element 306 is arranged at the center in the X direction. This makes it possible to perform appropriate heating control in each of all the unit areas 307.

In the present embodiment, NPN diodes are used as the temperature detection elements 306. Since an NPN diode has a larger current amplification factor than other diodes (for example, a PNP diode), it is possible to downsize the element substrate 301. In a case where the temperature detected by each temperature detection element 306 is equal to or lower than a predetermined value, the heating elements 304 heat the element substrate 301. Accordingly, the temperature of the liquid in each unit area 307 is maintained at a predetermined temperature suitable for ejection.

Further, the element substrate 301 has the two long sides extending in the first direction (the X direction) and the two short sides extending in the second direction (the Y direction). At the end portion of the element substrate 301 in the −Y direction, a plurality of pads for connecting to the outside is arranged along the long side of the element substrate 301, thereby forming the one pad array 302a. The plurality of pads constituting the pad array 302a includes a signal pad, which receives selection data for the heaters 303 that are driven for ejection, a power supply pad, etc.

The configuration is such that a current is applied to the heaters 303 at any desired timings via these pads for heating the heaters 303, thereby causing heating and bubbling of liquid, so that droplets can be ejected from the ejection ports. Note that, various elements such as piezoelectric elements can also be used as the energy generating elements for ejecting the droplets.

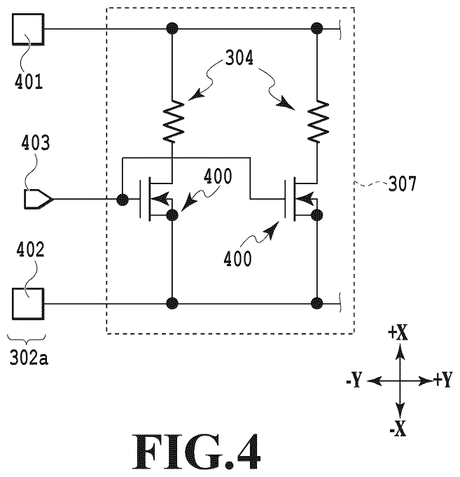

FIG. 4 is a diagram illustrating a circuit for driving the heating elements 304 in one unit area 307.

As illustrated in FIG. 4, in one unit area 307, the two heating elements 304 are electrically connected in parallel to the drivers 400 in order to efficiently heat the periphery of the heaters 303 (not illustrated in FIG. 4).

The pad array 302a includes the first pad 401 and the second pad 402. The first pad 401 is a + power supply pad. The second pad 402 is a GND pad. The first pad 401 and the second pad 402 are used to supply power to the heating elements 304, but may be commonly used as pads for supplying power to the heater 303 (see FIG. 3) used to eject droplets.

In the present embodiment, transistors are used as the drivers 400. The drivers 400 are controlled by a control signal for the heating elements 304. The control signal for the heating elements 304 is input from the signal line 403. The drivers 400 drive the two heating elements 304 simultaneously, so as to heat the any desired unit area 307 inside the element substrate 301.

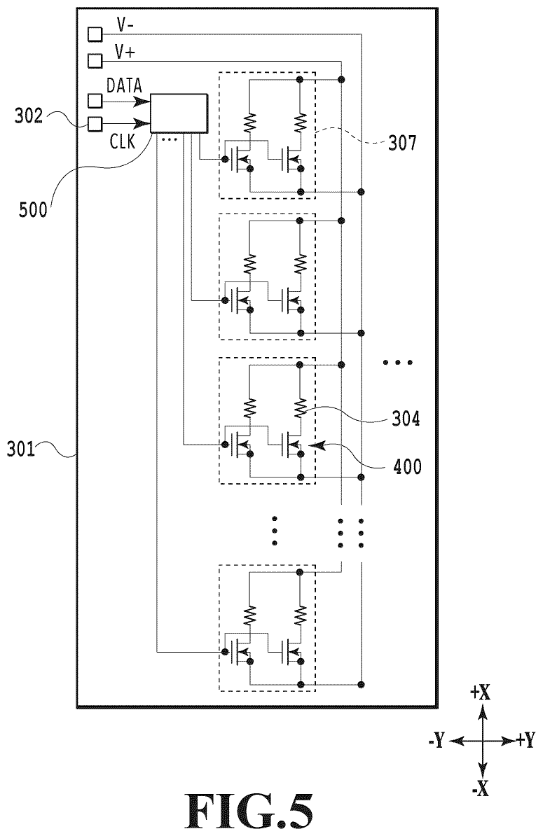

FIG. 5 is a block diagram illustrating a configuration in which a control signal for the heating elements 304 is generated within the element substrate 301.

In FIG. 5, the first data processing circuit 500 for generating a control signal for the heating elements 304 is installed within in the element substrate 301. In a case where a control signal for the heating elements 304 is generated within the element substrate 301, the control signal data is sent simultaneously with the image data, thereby allowing the heating elements 304 to be controlled without increasing the number of pads 302.

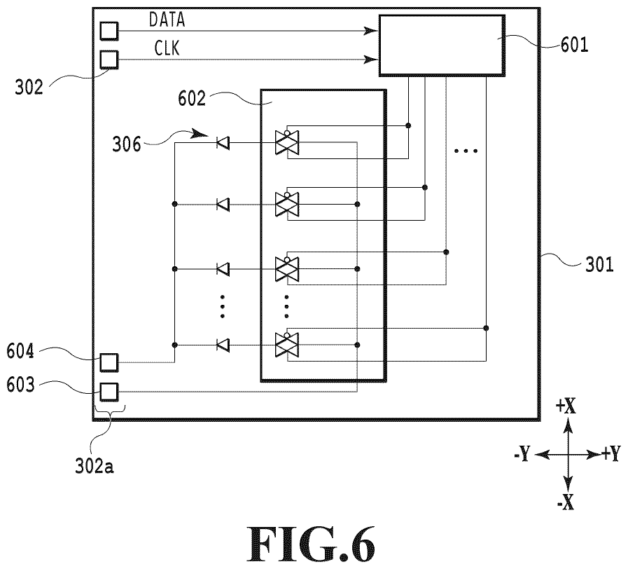

FIG. 6 is a block diagram illustrating a configuration in which a selection signal for the temperature detection elements 306 is generated within the element substrate 301.

The element substrate 301 includes switching elements for switching the selection of heating elements 304 (see FIG. 4, etc.) and temperature detection elements 306. Each of the plurality of temperature detection elements 306 and each of the plurality of heating elements 304 is connected to a different one of the above-mentioned switching elements. In each of the plurality of unit areas 307 (see FIG. 4, etc.), a control signal for switching between the selection of the heating elements 304 and the temperature detection element 306 is input to each of the switching elements.

As illustrated in FIG. 6, the second data processing circuit 601 for selecting a desired temperature detection element 306 is installed within the element substrate 301. The second data processing circuit 601 is connected to each of the temperature detection elements 306 via the multiplexer 602. By sending selection signal data for the temperature detection elements 306 simultaneously with image data, it is possible to perform selection control of the temperature detection elements 306 without increasing the number of pads 302.

Further, the pad array 302a (see FIG. 3) includes the third pad 603 and the fourth pad 604. The third pad 603 is connected to each of the temperature detection elements 306. The fourth pad 604 is a GND pad (VSS). The characteristics of the temperature detection elements 306 are measured by applying a constant electric current to the third pad 603 and reading the voltage value.

To obtain the temperature information of the element substrate 301, information detected based on a change in characteristics of the temperature detection elements 306 is electrically converted, and is input via the pad array 302a to a main circuit that] controls the liquid ejection head 101 (see FIG. 1) outside the liquid ejection head 101. It is also possible that this temperature information is input to a control circuit within the element substrate 301, not to the above-mentioned main circuit. Even with this configuration, the temperature of the element substrate 301 can be detected.

The detected temperature information is compared with a predetermined set temperature in a control circuit outside the element substrate 301 or within the element substrate 301. In a case where the temperature of a given unit area 307 is lower than the predetermined temperature, a control signal is input from the signal line 403 (see FIG. 4, etc.) connected to the drivers 400 (see FIG. 4, etc.) corresponding to this unit area 307.

Then, the heating elements 304 (see FIG. 4, etc.) installed in that unit area 307 are driven by the control signal. On the other hand, in a case where a temperature higher than the predetermined temperature is detected by the temperature detection element 306, the driving of the heating elements 304 (not illustrated in FIG. 6) corresponding to that unit area 307 is controlled to stop.

As described above, in the present embodiment, the heaters 303 and the heating elements 304 are arranged in all of the unit areas 307. Further, in each of the unit areas 307 installed in the first area 307a, the temperature detection element 306 is arranged at the center in the X direction.

Further, in each of the unit areas 307 installed in the second area 307b and the third area 307c, the temperature detection element 306 is arranged as far away from the center of the element substrate 301 as possible in the longitudinal direction. According to this configuration, it is possible to detect an average temperature close to the actual temperature in each of the unit areas 307 of the element substrate 301, and thus the accuracy in temperature detection can be made approximately uniform over the entire substrate.

Therefore, according to the print element substrate of the present embodiment, temperature can be accurately detected over the entire area, and high-precision temperature control can be performed.

Furthermore, since the accuracy of temperature detection in each unit area 307 becomes approximately uniform, the precision of heating control by the heating elements 304 in each unit area 307 also becomes approximately uniform. In this way, according to a liquid ejection apparatus equipped with the liquid ejection heads of the present disclosure, heating control is performed more precisely than with conventional technologies, thereby making it possible to suppress deterioration in image quality more effectively than in the conventional technologies.

### Modification Example of the First Embodiment

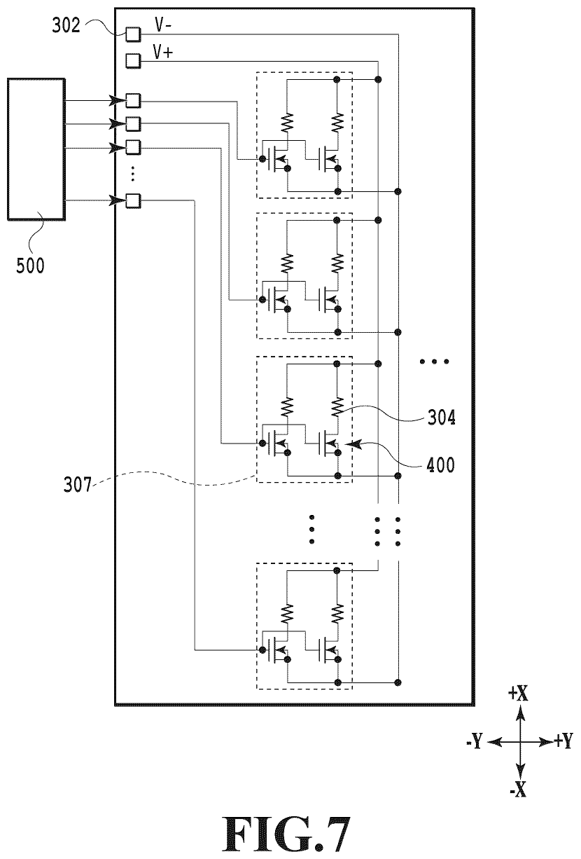

FIG. 7 is a block diagram illustrating a modification example of the configuration in which a control signal for the heating elements 304 is supplied from outside the element substrate 301.

In FIG. 7, the first data processing circuit 500 is arranged outside the element substrate 301. With this configuration, it is also possible to detect temperature more accurately than in the conventional technologies.

### Second Embodiment

Hereinafter, the second embodiment of the technology of the present disclosure is described with reference to the drawings. In the following description, the same names and signs are assigned to components that are the same as or correspond to those in the first embodiment, and descriptions thereof are omitted, with emphasis placed on different aspects.

The present embodiment provides a technology capable of accurately detecting temperature even with an elongated print element substrate.

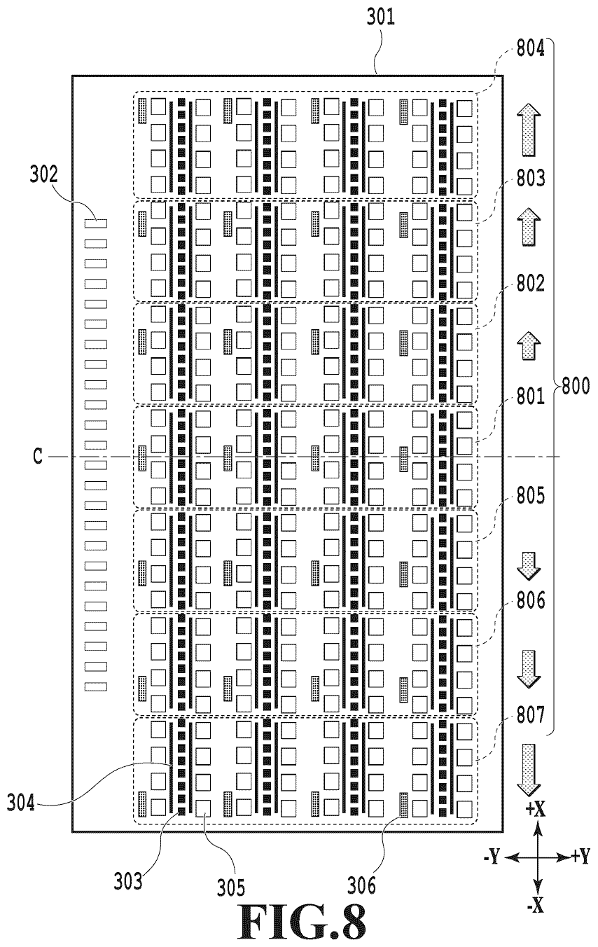

FIG. 8 is a plan view illustrating an example of the element substrate 301 applicable to the present embodiment.

As illustrated in FIG. 8, the element substrate 301 of the present embodiment has the unit areas 800. The unit areas 800 include the unit area 801, the unit area 802, the unit area 803, the unit area 804, the unit area 805, the unit area 806, and the unit area 807. In the plan view of the bottom surface of the element substrate 301, the unit area 804, the unit area 803, the unit area 802, the unit area 801, the unit area 805, the unit area 806, and the unit area 807 are arranged in this order from one end to the other end in the longitudinal direction (the X direction).

In the present embodiment, temperature detection by the temperature detection elements 306 and heating control by the heating elements 304 are performed in each of these seven unit areas. In the unit area 801 located at the center in the X direction, the temperature detection elements 306 are arranged at the center of the unit area 801 in the X direction (the center C of the element substrate 301 in the X direction).

In the unit area 802 adjacent to the unit area 801 on the +X direction side, the temperature detection elements 306 are arranged on the +X direction side relative to the center of the unit area 802 in the X direction. The distance from the temperature detection elements 306 in the unit area 802 to the end portion of the unit area 802 on the +X direction side is shorter than the distance from the temperature detection elements 306 in the unit area 801 to the end portion of the unit area 801 on the +X direction side.

In the unit area 803 adjacent to the unit area 802 on the +X direction side, the temperature detection elements 306 are arranged on the +X direction side relative to the center of the unit area 803 in the X direction. The distance from the temperature detection elements 306 in the unit area 803 to the end portion of the unit area 803 on the +X direction side is shorter than the distance from the temperature detection elements 306 in the unit area 802 to the end portion of the unit area 802 on the +X direction side.

In the unit area 804 adjacent to the unit area 803 on the +X direction side, the temperature detection elements 306 are arranged on the +X direction side relative to the center of the unit area 804 in the X direction. The distance from the temperature detection elements 306 in the unit area 804 to the end portion of the unit area 804 on the +X direction side is shorter than the distance from the temperature detection elements 306 in the unit area 803 to the end portion of the unit area 803 on the +X direction side.

On the other hand, in the unit area 805 adjacent to the unit area 801 on the −X direction side, the temperature detection elements 306 are arranged on the −X direction side relative to the center of the unit area 805 in the X direction. The distance from the temperature detection elements 306 in the unit area 805 to the end portion of the unit area 805 on the −X direction side is shorter than the distance from the temperature detection elements 306 in the unit area 801 to the end portion of the unit area 801 on the −X direction side.

In the unit area 806 adjacent to the unit area 805 on the −X direction side, the temperature detection elements 306 are arranged on the −X direction side relative to the center of the unit area 806 in the X direction. The distance from the temperature detection elements 306 in the unit area 806 to the end portion of the unit area 806 on the −X direction side is shorter than the distance from the temperature detection elements 306 in the unit area 805 to the end portion of the unit area 805 on the −X direction side.

In the unit area 807 adjacent to the unit area 806 on the −X direction side, the temperature detection elements 306 are arranged on the −X direction side relative to the center of the unit area 807 in the X direction. The distance from the temperature detection elements 306 in the unit area 807 to the end portion of the unit area 807 on the −X direction side is shorter than the distance from the temperature detection elements 306 in the unit area 806 to the end portion of the unit area 806 on the −X direction side.

As described above, in the present embodiment, with respect to the longitudinal direction (the X direction), the temperature detection elements 306 are arranged such that the distance from each temperature detection element 306 to an end portion of the unit area gradually decreases as the distance from the center C of the element substrate 301 increases. That is, the configuration is such that the closer a unit area is arranged to an end portion of the element substrate 301, the shorter the distance is from the temperature detection element 306 to an end portion of the unit area.

For example, in the unit area 804 which is installed closest to the +X direction side end and the unit area 807 which is installed closest to the −X direction side end, the distance from the temperature detection elements 306 to the end portion of each unit area is the shortest. This allows the plurality of the temperature detection elements 306 to be uniformly arranged over the entire area of the element substrate 301 from one end portion to the other end portion. Such a configuration is particularly effective in a case where the length of the element substrate 301 in the X direction is elongated.

In a case where a print head is elongated to accommodate large-format printing sheet and the length of a print element substrate in the X direction is elongated accordingly, a temperature difference is likely to occur between the central portion and the end portions within the element substrate 301. As in the present embodiment, with such an arrangement in which the farther a unit area is located away from the center C, the farther the temperature detection elements 306 are positioned away from the center C, it becomes possible to accurately perform temperature detection in each unit area.

Therefore, according to the technology of the present embodiment, temperature can be accurately detected even with an elongated print element substrate.

### Third Embodiment

Hereinafter, the third embodiment of the technology of the present disclosure is described with reference to the drawings. In the following description, the same names and signs are assigned to components that are the same as or correspond to those in the first to second embodiments, and descriptions thereof are omitted, with emphasis placed on different aspects.

The present embodiment provides a print element substrate capable of accurately detecting the temperature of the end portion on the opposite side of the end portion where the pad array 302a is arranged.

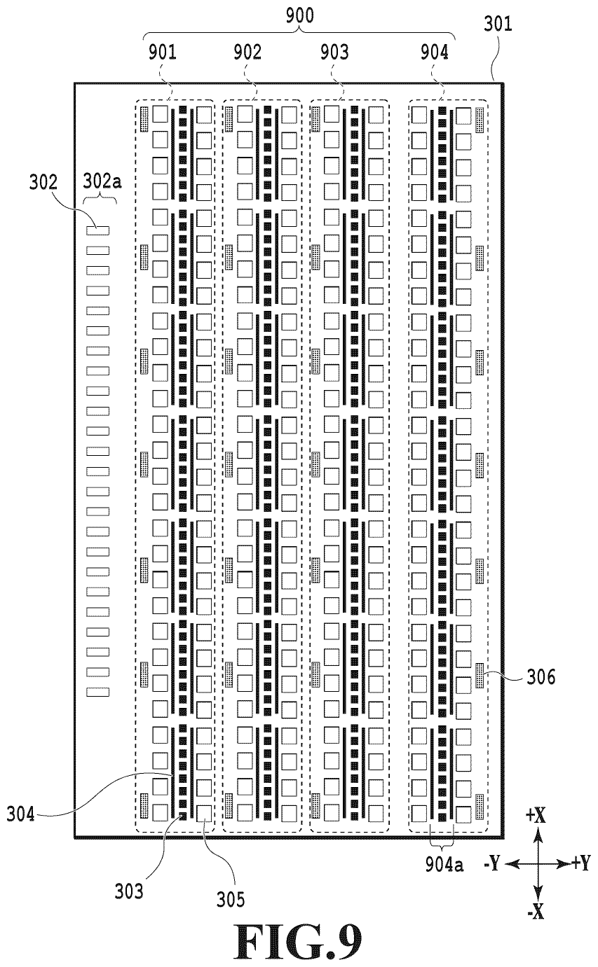

FIG. 9 is a plan view illustrating an example of the element substrate 301 applicable to the present embodiment.

As illustrated in FIG. 9, the unit areas 900 of the element substrate 301 include the unit area 901, the unit area 902, the unit area 903, and the unit area 904 arranged in order along the second direction (the Y direction) from the one closest to the pad array 302a. In this manner, among the unit area 901, the unit area 902, the unit area 903, and the unit area 904, the unit area 904 is located at a position farthest from the pad array 302a. In the unit area 904, the temperature detection elements 306 are arranged as far away from the pad array 302a as possible.

In a case where the pad array 302a is arranged at the end portion of one side (in the present embodiment, the −Y direction side) of the element substrate 301, the distance between the heaters 303 and the end portion on the opposite side (the +Y direction side) is closer. Thus, the temperature of the unit area 904 tends to be lower than that of the other unit areas. That is, there is a possibility that a difference occurs between the ejection of the unit area 904 and the ejection of the unit areas 901 to 903.

Therefore, in the unit area 904 of the present embodiment, a plurality of the temperature detection elements 306 is arranged along the end portion (the end portion on the +Y direction side) of the element substrate 301 so as to be as far away from the pad array 302a as possible. This allows the temperature drop in the unit area 904 located at the position farthest from the pad array 302a to be effectively reflected in the temperature detection.

Therefore, with the element substrate 301 of the present embodiment, it is possible to accurately detect the temperature of the end portion on the opposite side of the end portion where the pad array 302a is arranged, and high-precision temperature control can be performed.

### Fourth Embodiment

Hereinafter, the fourth embodiment of the technology of the present disclosure is described with reference to the drawings. In the following description, the same names and signs are assigned to components that are the same as or correspond to those in the first to third embodiments, and descriptions thereof are omitted, with emphasis placed on different aspects.

The present embodiment provides a print element substrate capable of accurately detecting the temperature of a corner portion.

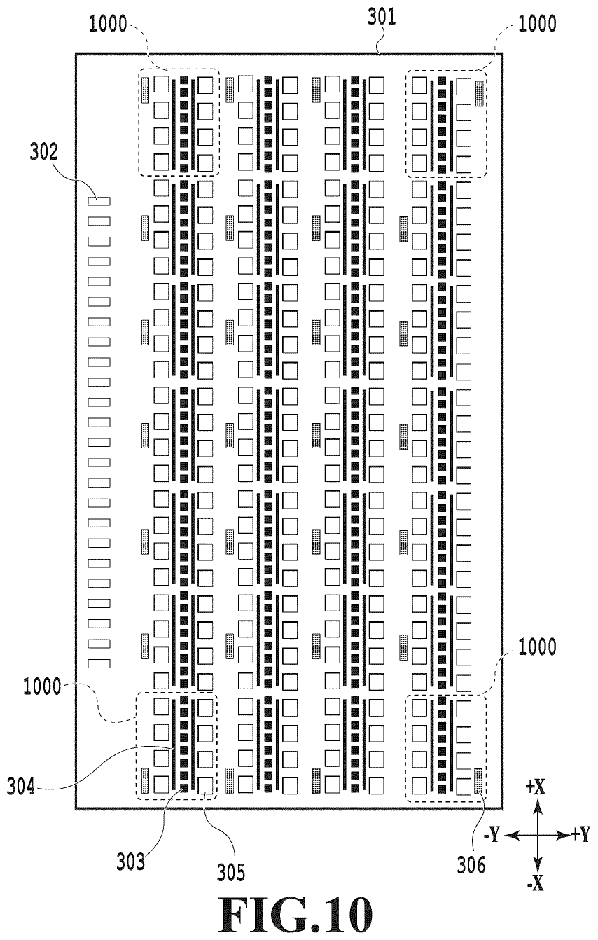

FIG. 10 is a plan view illustrating an example of the element substrate 301 applicable to the present embodiment.

As illustrated in FIG. 10, the element substrate 301 of the present embodiment has the four unit areas 1000 arranged at the corner portions. In each of these unit areas 1000, the temperature detection element 306 is arranged near a corner of the element substrate 301. Since the corners of the element substrate 301 are adjacent to two sides, heat can escape more easily than from the end portions in contact with only one side, and thus the temperature can be reduced more easily.

Therefore, at the corner portions of the element substrate 301 in the present embodiment, the temperature detection elements 306 are arranged near the corners of the element substrate 301. This makes it easier for the temperature drop at the corner portions of the element substrate 301 to be reflected in the temperature detection, thereby enabling the temperature to be detected effectively.

Therefore, according to the element substrate 301 of the present embodiment, the temperature of the corner portions of the element substrate 301 can be accurately detected, and high-precision temperature control can be performed.

### Fifth Embodiment

Hereinafter, the fifth embodiment of the technology of the present disclosure is described with reference to the drawings. In the following description, the same names and signs are assigned to components that are the same as or correspond to those in the first to fourth embodiments, and descriptions thereof are omitted, with emphasis placed on different aspects.

The present embodiment provides the element substrate 301 capable of accurately detecting the temperature of end portions and corner portions.

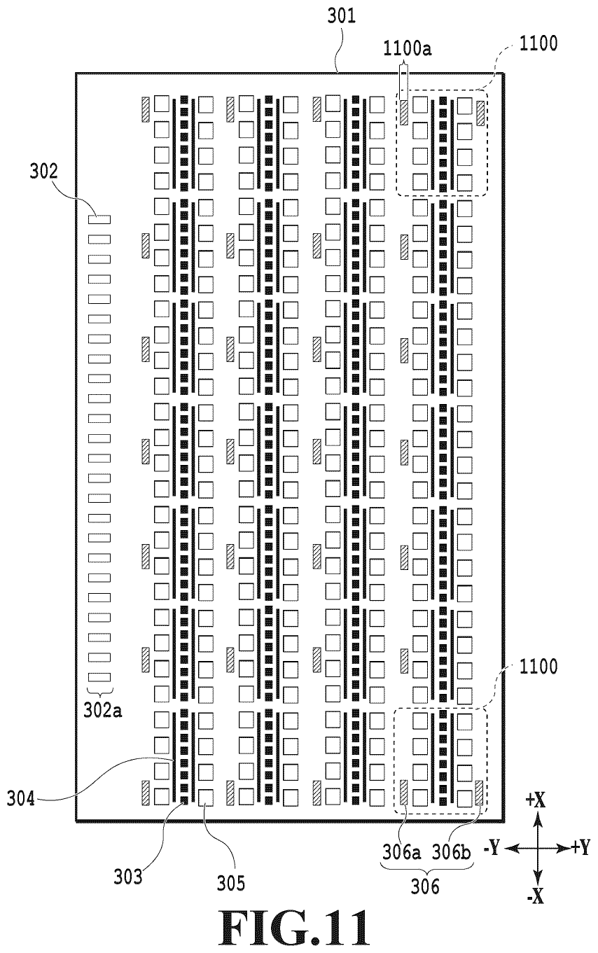

FIG. 11 is a plan view illustrating an example of the element substrate 301 applicable to the present embodiment.

As illustrated in FIG. 11, two temperature detection elements 306 are arranged in each of the unit areas 1100 located at the corner portions of an end portion (the end portion on the +Y direction side), which is on the opposite side of the end portion where the pad array 302a is arranged. In the unit areas 1100, one temperature detection element 306 is arranged on the outside of each of the two supply port arrays. In FIG. 11, for convenience of explanation, these two temperature detection elements 306 are referred to as the temperature detection element 306a and the temperature detection element 306b, respectively.

In the unit areas 1100, the temperature detection element 306a is arranged on the line of the temperature detection element array 1100a, which is arranged at the end portion on the opposite side of the pad array 302a (the end portion on the +Y direction side). On the other hand, in the unit areas 1100, the temperature detection element 306b is arranged at a position as close to a corner of the element substrate 301 as possible.

As described above, the temperature at end portions and corner portions of the element substrate 301 tends to drop more easily than at the central portion of the element substrate 301. Therefore, in the present embodiment, the temperature detection elements 306 are further added to each of the two corner portions sandwiching the side (the +Y direction side) which is the opposite side of the pad array 302a.

Therefore, according to the element substrate 301 of the present embodiment, the temperature of end portions and corner portions can be accurately detected, and high-precision temperature control can be performed.

### Sixth Embodiment

Hereinafter, the sixth embodiment of the technology of the present disclosure is described with reference to the drawings. In the following description, the same names and signs are assigned to components that are the same as or correspond to those in the first to fifth embodiments, and descriptions thereof are omitted, with emphasis placed on different aspects.

In the first to fifth embodiments, the pad array is arranged along the longitudinal direction (the X direction) at the end portion on the −Y direction side of the element substrate. On the other hand, in the present embodiment, the pad array is arranged along the transverse direction (the Y direction) at each of the end portions of the element substrate on the +X direction sides. The present embodiment provides a print element substrate capable of accurately detecting temperature with the configuration in which pad arrays are arranged along the transverse direction.

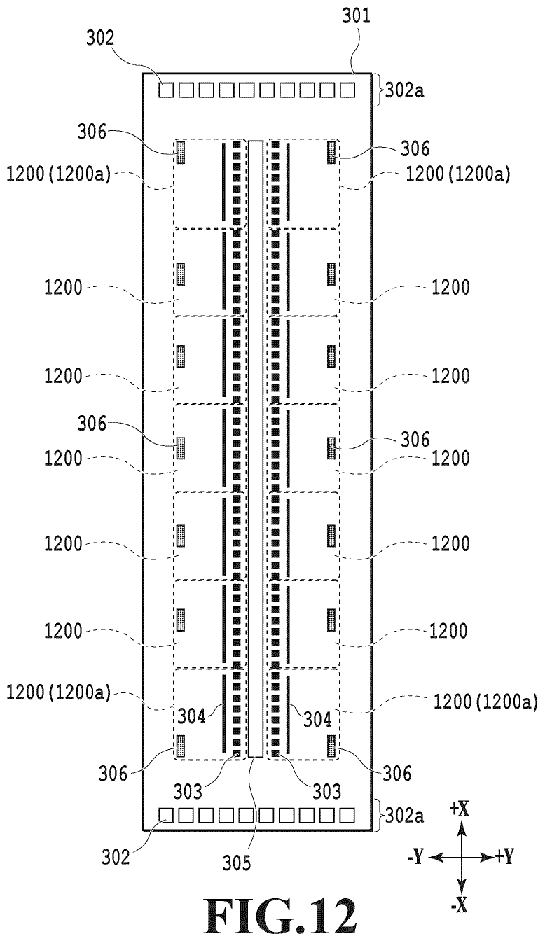

FIG. 12 is a plan view illustrating an example of the element substrate 301 applicable to the present embodiment.

As illustrated in FIG. 12, at both end portions in the longitudinal direction (the X direction) of the element substrate 301 in the present embodiment, the pad arrays 302a are arranged along the transverse direction (the Y direction). The one supply port 305 is formed at the center of the element substrate 301 with respect to the transverse direction (the Y direction), so as to extend along the longitudinal direction (the X direction). One heater array is formed on each side of the supply port 305. Outside the ejection port arrays in the element substrate 301, heating element arrays are formed along the longitudinal direction (the X direction). The temperature detection elements 306 are arranged outside the heating element arrays in the element substrate 301.

In the present embodiment, seven unit areas 1200 are formed along the longitudinal direction (the X direction) and two unit areas 1200 are formed along the transverse direction (the Y direction). Each of the fourteen unit areas 1200 includes eight heaters 303, one heating element 304, and one temperature detection element 306. Note that the numbers of heaters 303, heating elements 304, and temperature detection elements 306 are not limited to the above-described numbers. Hereinafter, for ease of explanation, the four unit areas located at the four corners among these fourteen unit areas 1200 are referred to as the “unit areas 1200a.” In the unit areas 1200a, the temperature detection elements 306 are arranged as close to a corner portion of the element substrate 301 as possible.

For example, in the unit area 1200a located at the upper left corner portion in the drawing, the temperature detection element 306 is arranged at the upper left corner portion. In the unit area 1200a located at the upper right corner portion in the drawing, the temperature detection element 306 is arranged at the upper right corner portion. In the unit area 1200a located at the lower left corner portion in the drawing, the temperature detection element 306 is arranged at the lower left corner portion. In the unit area 1200a located at the lower right corner portion in the drawing, the temperature detection element 306 is arranged at the lower right corner portion.

Further, regarding the unit areas 1200 other than these four, the temperature detection element 306 is arranged at an end portion of the transverse direction (the Y direction) and the center of the longitudinal direction (the X direction) in each unit area 1200. That is, the temperature detection elements 306 are uniformly arranged at positions near the end positions and corner portions, where the temperature is more likely to drop than in the central portion of the element substrate 301.

Therefore, according to the element substrate 301 of the present embodiment, in a configuration where the pad arrays 302a are arranged at both end portions on the longitudinal direction sides, it is possible to accurately detect the temperature of end portions and corner portions and to perform high-precision temperature control. [Other Embodiment]

The above-described embodiments may be combined depending on the size of the print element substrate and the state of heat dissipation from the end portions.

In the first embodiment, the temperature detection elements are configured with NPN diodes. However, the configuration of the temperature detection elements is not limited to NPN diodes as long as the temperature of the print element substrate can be detected. For example, even in a case where PNP diodes are used as the temperature detection elements 306, the same effects as those of the first embodiment can be obtained.

Further, it is also possible that the temperature detection elements are configured using a layer that forms wiring. In a case where this configuration is adopted, in order to increase the resistance value at the portions where temperature is detected, a wiring layer made of single-layer A1 may be formed in a serpentine planar layout at that portions, for example. Even with this configuration, it is also possible to obtain the same effects as in the first embodiment.

According to the print element substrate of the present disclosure, temperature can be accurately detected over the entire area, and high-precision temperature control can be performed.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-121183, filed Jul. 26, 2024, which are hereby incorporated by reference herein in its entirety.

What is claimed is:

1. A print element substrate for printing by ejecting liquid, the print element substrate comprising:
an energy generating element array configured with a plurality of energy generating elements arranged along a first direction to generate energy for ejecting the liquid;
a temperature detection element array configured with a plurality of temperature detection elements arranged along the first direction to detect a temperature of the print element substrate;
a heating element array configured with a plurality of heating elements arranged along the first direction to heat the print element substrate; and
a plurality of unit areas each configured to include at least one of the energy generating elements, at least one of the temperature detection elements, and at least one of the heating elements,
wherein, among the plurality of unit areas, compared to a first unit area arranged in a near of a center of the print element substrate, in a second unit area arranged at a position near a first end portion of the print element substrate, the temperature detection element is arranged at a position close to the first end portion.

2. The print element substrate according to claim 1,
wherein, in the first unit area, the temperature detection element is centrally arranged with respect to the first direction.

3. The print element substrate according to claim 1,
wherein, in a third unit area arranged at a position near a second end portion, which is located on the opposite side of the side where the first end portion is located with respect to the center of the print element substrate, the temperature detection element is arranged at a position close to the second end portion.

4. The print element substrate according to claim 3,
wherein, in a fourth unit area arranged between the first unit area and the second unit area, the temperature detection element is arranged at a position close to the end portion near the second unit area, and
wherein, in a fifth unit area arranged between the first unit area and the third unit area, the temperature detection element is arranged at a position close to the end portion near the third unit area.

5. The print element substrate according to claim 1 further comprising
a pad array configured with a plurality of pads arranged along the first direction at one end portion with respect to a second direction that intersects the first direction,
wherein, in a unit area arranged at a position farthest from the pad array, the temperature detection element is arranged at a position close to the other end portion with respect to the second direction.

6. The print element substrate according to claim 5,
wherein, among the plurality of unit areas, in a unit area arranged near a corner of the print element substrate, the temperature detection element is arranged at a position close to the corner of the print element substrate.

7. The print element substrate according to claim 6,
wherein, among the plurality of unit areas, in a unit area positioned far from the pad array and arranged near a corner of the print element substrate, a plurality of the temperature detection elements is arranged so as to face each other with the heating element and the energy generating element interposed therebetween.

8. The print element substrate according to claim 1,
wherein a plurality of unit area arrays, each including a plurality of the unit areas arranged along the first direction, is arranged along a second direction that intersects the first direction in a plane,
wherein, in each unit area constituting a unit area array arranged at one end portion with respect to the second direction among the plurality of unit area arrays, the temperature detection element is arranged close to the one end portion with respect to the second direction, and
wherein, in each unit area constituting a unit area array arranged at the other end portion with respect to the second direction among the plurality of unit area arrays, the temperature detection element is arranged close to the other end portion with respect to the second direction.

9. The print element substrate according to claim 1,
wherein the unit areas include at least one of the temperature detection elements and at least one of the heating elements.

10. The print element substrate according to claim 3,
wherein, among the plurality of unit areas, in each unit area excluding the second unit area and the third unit area, the temperature detection element and the heating element have the same positional relationship as in the first unit area.

11. The print element substrate according to claim 1,
wherein the temperature detection elements are configured with NPN diodes.

12. The print element substrate according to claim 1,
wherein the temperature detection elements are configured using a layer that forms wiring.

13. The print element substrate according to claim 1 further comprising
switching elements configured to switch the selection of the heating elements and the temperature detection elements,
wherein each of the plurality of heating elements and each of the plurality of temperature detection elements is connected to a different one of the switching elements.

14. The print element substrate according to claim 13,
wherein, in each unit area among the plurality of unit areas, a control signal for switching the selection of the heating elements and the temperature detection elements is input to each of the plurality of switching elements.

15. The print element substrate according to claim 1,
wherein the heating element heats the print element substrate in a case where a temperature detected by the temperature detection element corresponding to the heating element is equal to or lower than a predetermined temperature.

16. The print element substrate according to claim 1,
wherein a power supply pad for supplying power to the plurality of heating elements is the same as an electric power source for supplying power to the plurality of energy generating elements.

17. The print element substrate according to claim 13,
wherein a power supply pad connected to the plurality of heating elements is connected to the same GND pad as a GND pad connected to the plurality of energy generating elements via the switching elements.

18. A liquid ejection head comprising
the print element substrate according to claim 1,
wherein a plurality of the print element substrates is arranged along the first direction.

19. A liquid ejection apparatus comprising:
a liquid ejection head configured to include the print element substrate according to claim 1; and
a control unit configured to control temperature of the print element substrate on a per unit area basis by driving the heating elements based on temperatures obtained by the temperature detection elements.
